(19) United States
(12) Patent Application Publication
(10) Pub. No.: US 2006/0016314 A1
(43) Pub. Date: Jan. 26, 2006

(54) Hybrid cutting device

(76) Inventor: Guy Gaudreault, Forestville (CA)

Correspondence Address: GUY GAUDREAULT, 26, 7e RUE, FORESTVILLE, QC, G0T 1E0, CA

(21) Appl. No.: 11/172,807

(22) Filed: Jul. 5, 2005

(30) Foreign Application Priority Data
Jul. 5, 2004 (CA) 2,274,345

(51) Int. Cl. B23D 57/00; B27B 13/02

(52) U.S. Cl. 83/835

(57) ABSTRACT

This invention relates to a hybrid cutting device for grinders used in the land clearing and wood grinding industry. The disclosure describes a cutting device composed of cutters placed in line to form a helix on a rotor, made of three forged steel parts. This device is assembled by welding and bolting. It can be used on an horizontal axis cutter head, composed of an hybrid cutter of inverted L shape to shred wood, a cutter support used to secure firmly the cutter on the rotor and an anti-wear steel part called “rocker”, allowing the absorption of shocks in place of the cutter and thus allowing a better protection against wear and damage. This system allows further aggressive and efficient usage of the cutter head by considerably reducing the vibration level or cutter damage.

### DISCLOSURE

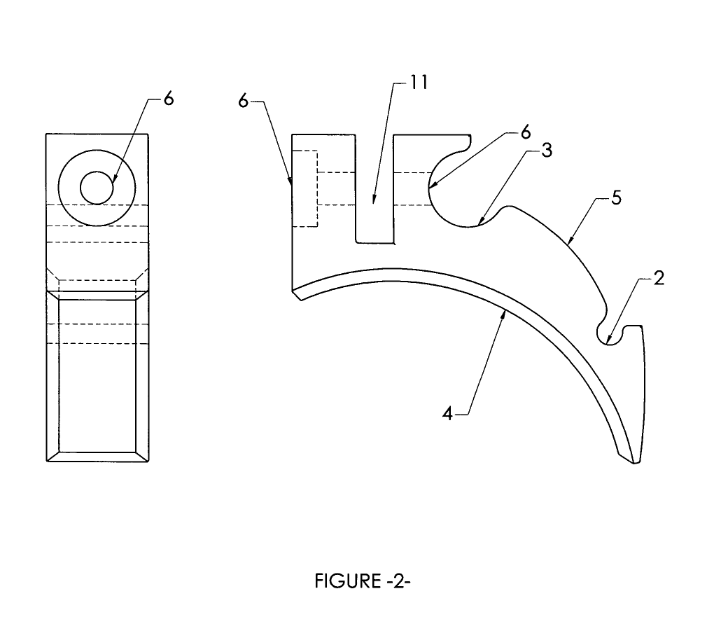

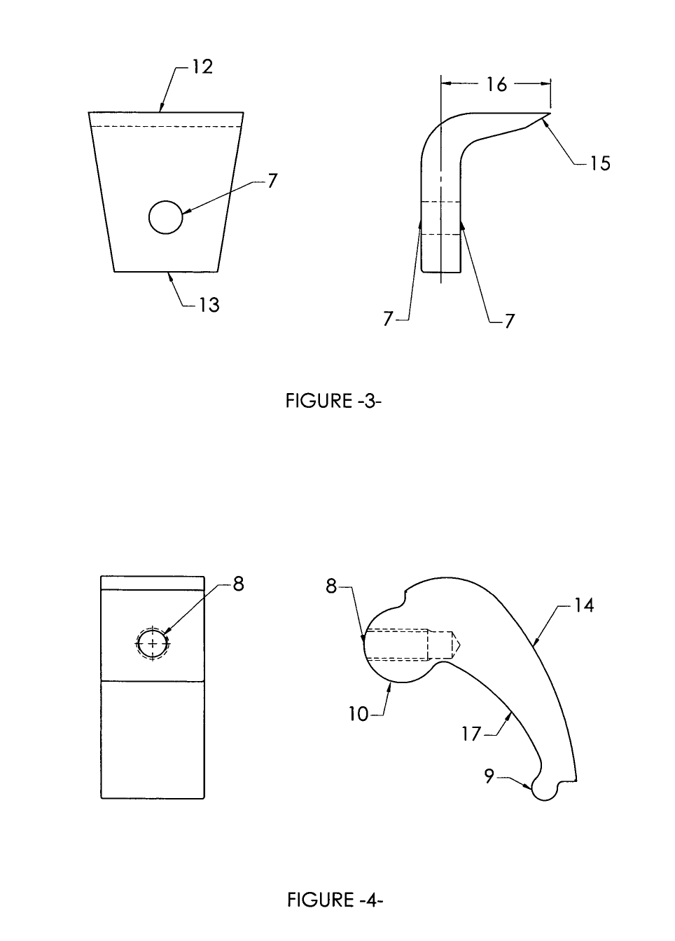

This invention relates to a cutting device used as a cutting tool on horizontal axis cutter heads used in forestry industry. Cutters on horizontal shafts are commonly used to shred wood. Specifically, this concerns a hybrid cutting device provided with innovative characteristics significantly improving the efficiency of such a device, for instance, the cutter support, (FIG. 2) the inverted L shape cutter (FIG. 3) and the steel anti-wear part called a “rocker”. To protect the cutter from the impact of a rock or very resilient wood and to control the wood cutting depth. With research it is possible to limit the cutting area thus making this machine very efficient and providing even and gentle cutting behaviour for the rotor's working parts. It is also possible to adjust the cutter height with the steel anti-wear rocker part. With this method we can adjust the cutting area depending on rotor available power. This type of cutting device allows to cut vegetation very close to the ground while being very aggressive

In many occasions, vegetation clearing is required in industrial applications. In certain occasions the cutting operations imply clearing while on other occasions trees of diameters up to 12 inch must be brought down. In most occasions, the cut wood and cutting residue must be chipped to allow fast decomposition. Moreover, the cut wood is frequently of no commercial value. Many methods exist to carry out cutting and chipping operations. However the tool most used to carry out these two operations is a horizontal axis cutter head placed in front of a wheeled or tracked vehicle.

The major drawback of the existing fixed cutters available on the market is their brittleness. They are short and do not absorb impacts, these cutters are narrow and in most cases, these types of device are composed of a type of steel with a carbide tip which breaks rapidly in the event of an impact with a rock or metal debris. Generally speaking, the existing fixed cutter tend to break easily due to the choice of material and mostly because the cutters are not protected in the event of contact with very resilient medium. Without protection, the cutters absorb all the impact.

One of the cutter types used on the horizontal axis cutter heads is composed of a fixed cutter, often V-shaped, bolted on the horizontal shaft. These existing cutters have their drawbacks. Here is a description:
This cutter is very rigid with a carbide tip increasing the possibility of cracks in the event of a contact with rocks or metal debris. Moreover, the carbide tips are not sharp and do not cut. These cutters operate like hammers and not like cutters. This said, the shredding action is less efficient with the result that resistance and lifetime leaves something to be desired.
The length of the cutting edge of cutters presently offered does not allow cutter flexibility. Subsequently in shredding operation the cutter does not follow the cutting movement and this action leads to cracks and/or breaking. Efficiency is lowered if the cutting edge is too short. However, an edge too long will lead to quick breaking of the cutter.
No wear plate is proposed presently on the fixed cutter market. Without this part, there is a significant reduction of cutter lifetime. As there are no means of absorbing and protecting the cutter, premature wear occurs. This action limits efficiency while adding the possibility of vibrations thus accelerating component wear.

This invention has the objective of increasing cutter resistance and efficiency in the event of an impact with rocks or very resilient wood. The resulting benefit is increased productivity longer cutter lifetime and more production or cutting instead of crushing.

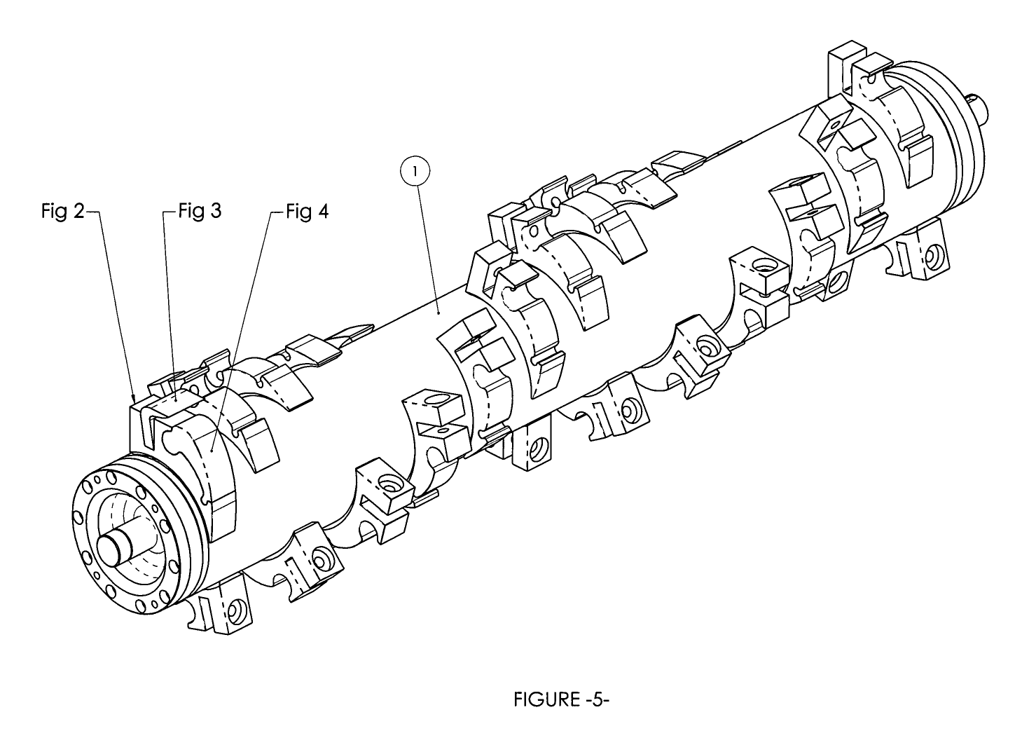

Our invention relates to cutters used on horizontal axis cutting heads and composed of three parts, for instance, the cutter (FIG. 3) the cutter support (FIG. 2) and a steel anti-wear part (FIG. 4). This cutter is secured firmly against the cutter support seat (11) by a bolt. The cutter support lower section (4) is welded on the horizontal shaft (1). This cutter support is made of one part and is composed of two round seats allowing to assemble and secure the steel anti-wear rocker part by keys (9 & 10). We have found that this steel anti-wear part allows to absorb the cutter impact thus extending the efficiency of the cutting edge and avoiding cutter premature breaking. Moreover this anti-wear part allows also to control wood cutting depth

This hybrid cutting device composed of three steel parts (FIG. 2, 3 and 4) is fixed by the inner face (4) of the cutter support, welded on the horizontal shaft (1). We use the upper face (5) of the cutter support (FIG. 2) to install the steel anti-wear part using one bolt passing through these parts by holes (6 & 8) so as to form an assembly. The upper section of the hybrid cutting device, for instance, the rocker anti-wear part (FIG. 4) has a semi-circular shape and has two round keys of different size (9&10), specifically, a small key (9) to assemble in the cutter support seat (2) and a larger key (10) assembled and screwed in the cutter support seat (3). This steel anti-wear part is made of one part and inserts in cutter support seats (2 & 3), forming an assembly by the bolt passing through the aforementioned three parts by holes (6, 7 & 8)

We have listed above the inherent drawbacks of cutters presently available on the market. Our invention has the objective of eliminating these weaknesses in the following manner:
We will use high strength alloy steel material. This material will allow to strengthen the cutter and provide a better cutter resistance at rock or resilient wood impact. Combined to a heat treatment giving exceptional durability to fabricated parts. This cutter will have high impact resistance. Cutter sharpening and breaking is significantly decreased and time between replacements is increased by our forging process that creates a wear resistant cutting edge (15).
Additionally this cutter is designed to avoid a clogging effect due to the accumulation of wood chips or debris under the cutter (vibration free). A major problem of cylindrical cutters, creating unbalance of the rotor. This process combined with thermal treatment ensures the constant weight essential to vibration suppression. The absence of particle accumulation allows not only to avoid vibration (by avoiding debris accumulation) but also provides maximum cutting at all times.
The proposed cutter has an inverted L shape with a carefully calculated cutting edge length (16) to provide a spring effect. It is this flexibility that allows the cutter to withstand impacts from rocks or hard objects.
Additionally the proposed cutter is inserted in the cutter seat and secured by a bolt passing through the proposed three parts by holes (6, 7 & 8) to form an assembly. The shape of the cutter support seat (11) fits perfectly with the cutter to create a solid implantation and fastening ( by bolting) on the horizontal axis cutter head. The cutter supports, commonly called “support” are welded individually along a helix line on the horizontal shaft.
To protect and absorb shocks on the proposed cutter, we have added a steel anti-wear part called “rocker” (FIG. 4). This steel anti-wear part with its upper face (14) absorbs the impact before the cutters, serves as protection, prolongs and avoids premature wear of the proposed cutters. Also, this steel anti-wear part prevents excessive cutter feeding in wood and allows to control the cutting depth. The proposed steel anti-wear rocker (FIG. 4) is composed of one part with two round keys (9&10), specifically, a small key (9) to assemble in the smaller cutter support seat (2) and a larger key to assemble and bolt in the larger cutter support seat (3). This steel anti wear rocker is secured by inserting the smaller key (9) in the smaller cutter support seat and the proposed steel part is solidly secured by the bigger key (10) inserted in the larger seat (3) through cutter support and rocker holes (6&8) (FIG. 3 and FIG. 4) of the proposed cutting device.

### The proposed invention provides the following advantages emphasized in the description below, in reference to the described drawings:

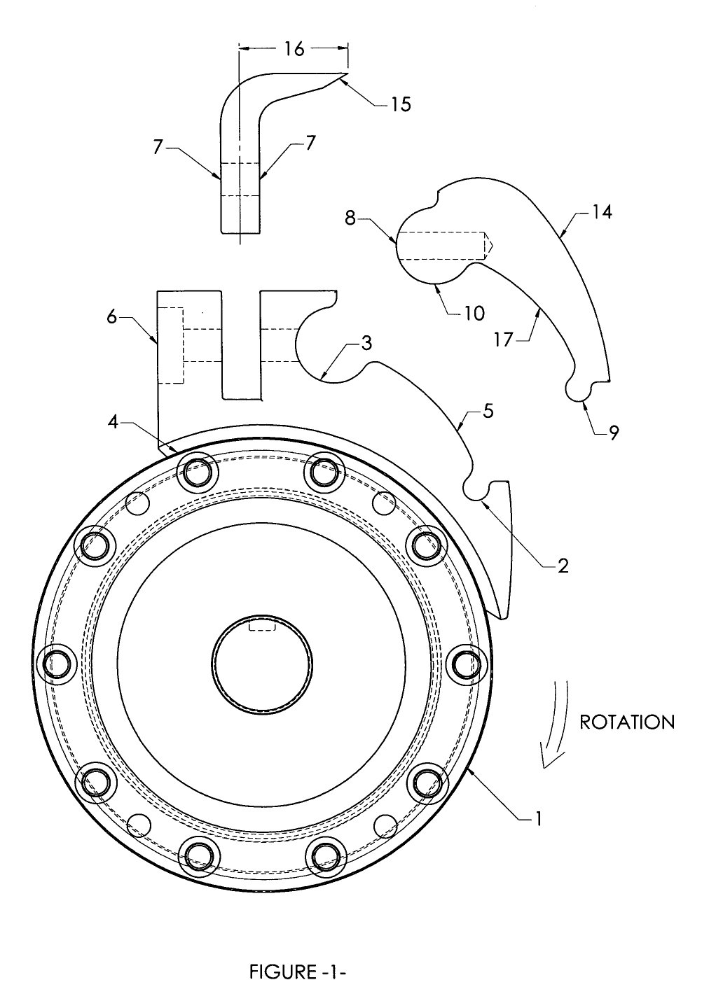

FIG. 1 is an exploded view of the proposed hybrid cutting device on a rotor.

FIG. 2 shows a schematic view of a cutter support with the specific features of our invention.

FIG. 3 shows a schematic view of the proposed cutter.

FIG. 4 shows a schematic view of the steel anti-wear part, called “rocker” with all the specific features to protect the cutter.

FIG. 5 shows a schematic view of the fixed cutters placed along a helix line on the rotor.

FIGS. 2, 3 and 4 show a cutter of the type generally used on horizontal shaft cutter heads. This cutter (FIG. 3) is composed of a cutting edge (15) of inverted L shape and fixed on the rotor by a cutter support (FIG. 2). The cutter support is composed of two round seats (2 & 3) and is welded by its lower face (4) on the rotor. This support is covered by a semi-circular steel anti-wear part called “rocker”, composed of two round keys (9 & 10) to mate with the two seats on the rotor welded part, namely, the cutter support. Subsequently in the event that the the anti-wear rocker comes in contact with a hard object it will absorb the impact before the cutter thus avoiding that the cutter receives the shock. Of course we cannot show the fabrication process of our cutter even if this is an innovation for this type of device. However here is a description:
Our cutter is fabricated of ultra high strength alloy steel. A forging process is used for each part required to compose the cutter, specifically: the cutter, the cutter support and the steel anti-wear part to secure and complete the hybrid cutting device. Additionally the cutters are exposed to a heat treatment designed to increase the hardness number, thus increasing wear resistance.

The achievements of the invention and claimed exclusive right of property or privilege are described as follows:

1. A fixed cutter arrangement with fixed cutters installed in line to form an helix on an horizontal axis cutting rotor designed to cut vegetation in industrial and forestry applications. Composed of three forged steel parts and assembled by welding and bolting, namely: a cutter, a cutter support and a steel anti-wear rocker as described in FIGS. 2, 3 and 4.

2. A cutter, composed of one part having an inverted L-shape oriented upside, the upper edge length (16) composed of the sharp edge (15) is wider (12) than the lower edge (13) inserted in the seat (11) of the cutter support.

3. A cutter, according to claim 2 composed of one part and made of heat treated high strength forged alloy steel to get superior wear resistance.

4. A cutter, according to claim 2 and 3, comprising a hole (7) to secure the cutter to the support seat (11) by a bolt passing through the three parts and forming the hybrid cutting device.

5. A cutter, according to claims 2, 3 and 4 with a carefully calculated cutting edge length (16) thus providing a spring effect.

6. An anti-wear forged steel rocker (FIG. 4) of semi-circular shape composed in its lower section (17) of two different round keys (9 & 10) made to insert in the two seats (2 & 3) of the upper section (5) of the cutter support. The anti-wear part is secured by a bolt, and by the lower key (10) screwed in the upper seat (3) of the cutter support

7. A forged steel cutter support welded (4) in line to form an helix on the rotor and composed in its upper section of two different round seats so as to receive the two different round keys (9 & 10) of the forged steel anti-wear rocker (FIG. 4). This part is composed also of a supplementary seat made specially to secure the cutter on the rotor. This cutter support secures the rocker and cutter with a common bolt passing through it from one side to the other, according to claim 1 of the cutting device.

8. It is understood that the achievements of the above described claims in reference to the attached drawings, namely FIGS. 1,2, 3 and 4, are provided for reference and are not subjected to any limitation. Modifications can be carried out without changing the essence of this invention.
